(19) United States
(12) Patent Application Publication
(10) Pub. No.: US 2013/0110741 A1
(43) Pub. Date: May 2, 2013

(54) MULTI-LEVEL AUTOMATED HEDGING PROCESS

(71) Applicant: Diogenes Duzoglou, Caracas (VE)

(72) Inventor: Diogenes Duzoglou, Caracas (VE)

(21) Appl. No.: 13/281,689

(22) Filed: Oct. 26, 2011

(51) Int. Cl. G06Q 40/06

(52) U.S. Cl. 705/36 R

(57) ABSTRACT

An automated method, computer system and computer program product for performing automated hedging activities is disclosed. The method includes receiving an investment strategy definition that defines at least one scenario associated with an initial position that must be executed. The method further includes receiving market data and searching the market data for the at least one scenario. The method further includes matching market data with the at least one scenario of the investment strategy definition and, responsive to matching the market data, executing the initial position associated with the at least one scenario. The method further includes matching market data with the at least one scenario of a first level hedging action and, responsive to matching the market data with the at least one scenario, executing the first level hedging action, thereby initiating a first level hedging position that hedges the initial position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of finance, and more particularly relates to the field of automated hedging methods.

### BACKGROUND OF THE INVENTION

Having a predefined investment and/or trading strategy is crucial in the volatile financial industry. When performing investment and trading activities, it is common for the novice investor to be swept up in the emotions of the market. In the case of a plunging market, mass panic can spread, causing investors to sell. In a bull market, investors buy in large quantities. Performing in a reactionary manner, however, is widely regarded as a poor investment strategy. A much more effective approach is to pre-plan an investment strategy so that an investor's activities are pre-determined and not subject to the emotions associated with the highs and lows of the market.

A commonly-used approach to mitigating risk in the market involves hedging. A hedge is an investment activity that lower the risk associated with another investment activity. The idea behind a hedge is that an investor does not want to take on the full risk of a first investment activity. Consequently, the investor performs a second, less-risky investment activity that, when combined with the first activity, results in a lower risk endeavor. An example of a hedge is accompanying the purchase of a high-risk stock with the purchase of a low-risk stock, resulting in a collective trade of moderate risk. Currently, however, there are no widely available, automated solutions for implementing a predefined investment strategy that involves multiple and complex hedging activities. Further, there are no current solutions that execute trading activities with adequate speed and fidelity.

Therefore, a need exists to overcome the problems with the prior art as discussed above, and particularly for a more efficient way of automating the process of implementing predefined investment strategies and executing hedging activities in a trading environment.

### SUMMARY OF THE INVENTION

Briefly, according to an embodiment of the present invention, an automated method, computer system and computer program product for performing automated hedging activities is disclosed. The method includes receiving, from an investor, an investment strategy definition that defines at least one scenario associated with a hedging action that must be executed. The method further includes receiving market data; searching the market data for the at least one scenario of the investment strategy definition; matching market data with the at least one scenario of the investment strategy definition; responsive to matching the market data, executing the initial position associated with the at least one scenario, wherein the initial position includes an interest having a first price; receiving market data; searching the market data for at least one scenario associated with a first level hedging action, wherein the at least one scenario comprises a first numerical value representing a value of the interest that corresponds to a predefined percentage of the maximum intended gain value and a second numerical value representing a value of the interest that corresponds to a predefined percentage of the maximum intended loss value; matching market data with the at least one scenario of the first level hedging action; responsive to matching the market data with the at least one scenario of the first level hedging action, executing the first level hedging action, thereby initiating a first level hedging position that hedges the initial position.

The foregoing and other features and advantages of the present invention will be apparent from the following more particular description of the preferred embodiments of the invention, as illustrated in the accompanying drawings.

### BRIEF DESCRIPTION OF THE DRAWINGS

FIG. 1 is a block diagram illustrating the network architecture of a system for providing management of hedging activities over a communications network, in accordance with one embodiment of the present invention.

FIGS. 2A and 2B is a flow chart that shows the control flow of a process for providing management of hedging activities over a communications network, in accordance with one embodiment of the present invention.

### DETAILED DESCRIPTION OF THE PREFERRED EMBODIMENTS

It should be understood that the embodiments below are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

The present invention, according to a preferred embodiment, overcomes problems with the prior art by providing an improved system, method and computer program product for performing hedging activities in an automated fashion. The present invention improves upon the prior art by allowing an investor to predefine an investment strategy, which is accompanied by a hedging process, wherein the investment strategy and hedging process are executed by a computer system, thereby removing the human element from the operation of buying and selling interests and eliminating the entry of emotion into investment decisions. The present invention also improves over the prior art by allowing for the definition of complex hedging actions, thereby allowing for higher fidelity in investment decisions and more control over investment activities.

The present invention further improves upon the prior art by providing an automatic hedging process that is executed automatically in conjunction with any predefined investment strategy. This allows users to continue to use their predefined investment strategies and simply add a hedging process to their strategies, thereby decreasing risk and increasing return of their existing investment strategies. This feature adds to the versatility of existing investment strategies and does not replace or modify an existing investment strategy.

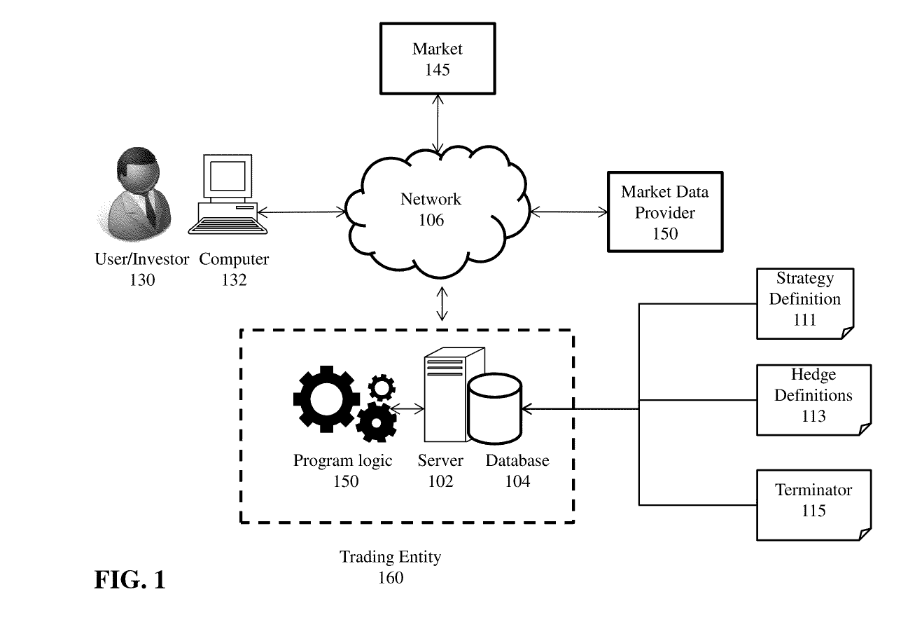

The present invention may be implemented in a computer system that may include a user/investor interface that connects with: 1) a trading entity (such as a financial services company), 2) a market, and 3) a market data provider that provides data about the market. Referring now to the drawing figures in which like reference designators refer to like elements, there is shown in FIG. 1 an illustration of a block diagram showing the network architecture of a system and method for providing management of hedging activities over a communications network in accordance with the principles of the present invention. The central element of FIG. 1 is network 106, which can be a circuit switched network, such as the Public Service Telephone Network or a packet switched network such as the Internet or the World Wide Web.

FIG. 1 further includes computer 132, which may be a smart phone, mobile phone, tablet computer, handheld computer, laptop, or the like. Computer 132 corresponds to user/investor 130. FIG. 1 further shows trading entity 160 comprising one more servers 102 and attached database 104. The trading entity 160 may be a trading platform, which is a computer system that can be used to place orders for financial products over a network with a market, such as market 145. Trading platforms allow electronic trading to be carried out by users from any location. Trading entity 160 may alternatively be a financial services company with an online presence.

The financial products handled by entity 160 may include shares, bonds, equities, currencies, commodities and derivatives with a financial intermediary, such as brokers, market makers, investment banks or stock exchanges. Financial products may also include equity, fixed-income, financial derivatives, currency, and other investment instruments. Financial products may further include participating in other exchanges such as a put, a put option, short sell, a call or another type of offer or contract to buy or sell at certain predefined prices. The aforementioned financial products are herein referred to collectively as “interests.”

FIG. 1 further shows market 145, which may be any one of a variety of systems, institutions, procedures, social relations and infrastructures whereby parties engage in exchange. Examples of a market include stock markets, stock exchanges (such as the New York Stock Exchange), bond markets, commodities markets, currency markets, foreign exchange markets, derivatives markets, prediction markets, and money markets. FIG. 1 also includes market data provider 150, which provides market data about one or more markets. Market data is quote and trade-related data associated with financial products and interests. Market data is numerical price data, reported from trading venues, such as stock exchanges. Market data provider 150 may be a financial data vendor that provides data to financial firms, traders, and investors. The data distributed is collected from sources such as stock exchange feeds, brokers and dealer desks or regulatory filings (e.g., an SEC filing).

It should be noted that although FIG. 1 shows only one investor 130, one computer 132, one trading entity 160, one market 145 and one market data provider 150, the system of the present invention supports any number of investors, computers, trading platforms, markets and market data providers connected via network 106.

Computer 132 and/or server 102 includes program logic 150 comprising computer source code, scripting language code or interpreted language code that is compiled to produce computer instructions that perform various functions of the present invention. Preferably, the program logic embodies: 1) a computer program for aiding a user 130 in defining an investment strategy, 2) an investment strategy embodied in a computer program, or a reasonable facsimile, by the user 130 or with his aid, with or without the aid of the computer program, 3) a computer program for implementing an investment strategy definition, 4) a computer program for implementing and/or executing hedging activities and/or 5) any combination of the preceding elements. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). The program logic 150 may reside on client computer 132, the server 102 or any combination of the two.

Note that although computer 132, server 102, database 104, market 145 and market data provider 150 are shown as single and independent entities, in one embodiment of the present invention, the functions of the aforementioned entities may be integrated with one another in different combinations and permutations. Further, computer 132, server 102, database 104, market 145 and market data provider 150 and their functionalities, according to a preferred embodiment of the present invention, can be realized in a centralized fashion in one computer system, or in a distributed fashion where different elements are spread across several interconnected computer systems.

The present invention revolves around the implementation of an investment strategy defined by the user 130, preferably on a computer readable medium. The definition of an investment strategy (i.e., an investment strategy definition 111) may define a scenario when an initial position must be executed or taken. A scenario may be defined by one or more times or dates, one or more prices for one or more interests, one or more identifiers for interests to purchase, and other related data. A scenario may also define an initial position that must be taken when one or more scenarios occur. An initial position may include the purchase, sale or trade of an interest. For example, a scenario may define a threshold price for a certain stock after a certain date. When this scenario is detected, the initial position is taken. Therefore, an investment strategy definition may be defined as a set of if-then statements, wherein the if-portion of the statement defines a scenario and the then-portion defines responsive positions that are taken when the scenario occurs.

The investment strategy definition may be fully defined by the user 130, with or without the aid of a computer program, and stored on a computer readable medium in database 104, though it may also be stored in computer 132. If aided by the computer program, when defining an investment strategy definition, the present invention may solicit certain information from the investor 130, such as his level of tolerance to certain fluctuations in the market, his risk status, his level of knowledge and/or experience with regard to particular markets and trading, his investment strategy's historical win/loss rate and/or win/loss amounts, the amount of capital or money he would like to risk losing (per time period, per position taken, etc.), the amount of gain he intends to realize (per time period, per position taken, etc.), the amount of loss he is comfortable realizing (per time period, per position taken, etc.), the amount of time he would like to hold each position and the amount of time he has available to participate in the investment activities. The present invention may also take other data into account, such as market data. An inference engine or expert advisor may provide an automated method for soliciting the aforementioned information from the investor 130. The investment strategy definition may further comprise defining a pair of commodities or currencies, which are bought or sold - or simply traded—against each other.

In addition to the data described above, the user 130 may further define certain data that are used by the program logic 150 of the present invention when executing its multi-tiered or multi-leveled hedging actions. This data may also be stored in the strategy definition 111. The user 130, may, for example, specify the dollar amount or size of each tier or level of hedging position taken, the amount of money he would like to risk losing (per time period, per position taken, per tier or level, etc.), the amount of gain he intends to realize (per time period, per position taken, per tier or level, etc.), the amount of loss he is comfortable realizing (per time period, per position taken, per tier or level, etc.), and the amount of time he would like to hold each level of hedging position.

Hedging actions may also be defined as a set of if-then statements, wherein the if-portion of the statement defines a scenario and the then-portion defines responsive hedging positions that are taken when the scenario occurs. Multiple levels of hedging actions may be defined in a hedge definitions file 113 and stored in database 104. Finally, there must be one or more scenarios that define when positions, whether it is an initial position or a hedge position, must be exited. This is referred to as a terminator action, which may also be defined as a set of if-then statements, wherein the if-portion of the statement defines a scenario and the then-portion defines a command to exit a position. If, for example, a current position comprises holding ownership of a stock or bond, then the exiting action for the current position would comprise selling the stock or bond. This terminator action data is defined in a terminator file 115 and stored in database 104.

The computer program of the present invention may receive and monitor market data, which may be provided by market data provider 150. The computer program may search the market data for the at least one scenario of the investment strategy definition and seek to match the market data with the at least one scenario of the investment strategy definition. Responsive to matching the market data with the at least one scenario, the computer program executes the initial position of the investment strategy definition. In other words, the computer program executes the if-then statements of the investment strategy definition. Subsequent to executing the if-then statements of the investment strategy definition, the computer program executes the hedging action(s) of the present invention, as described more fully below.

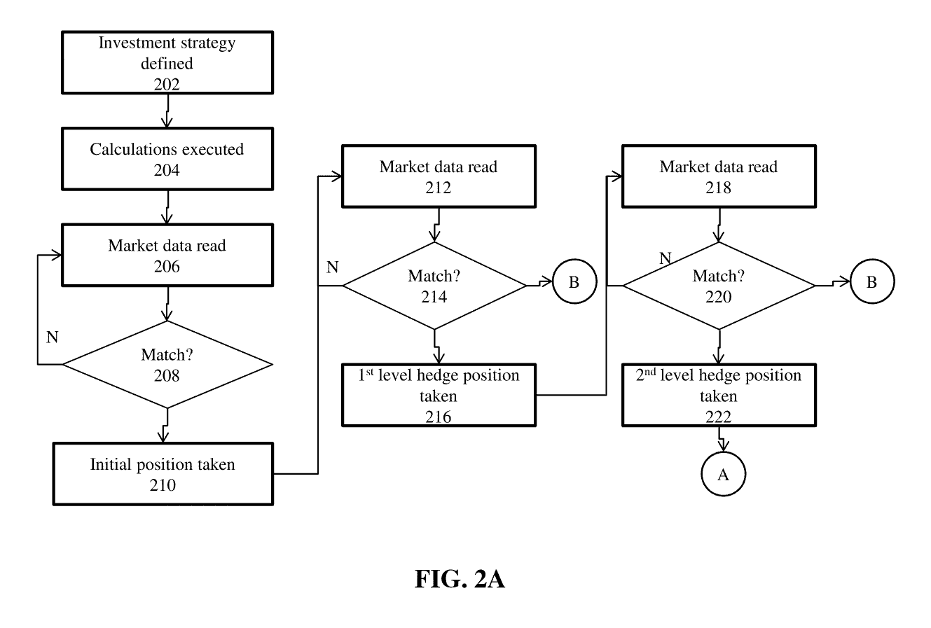

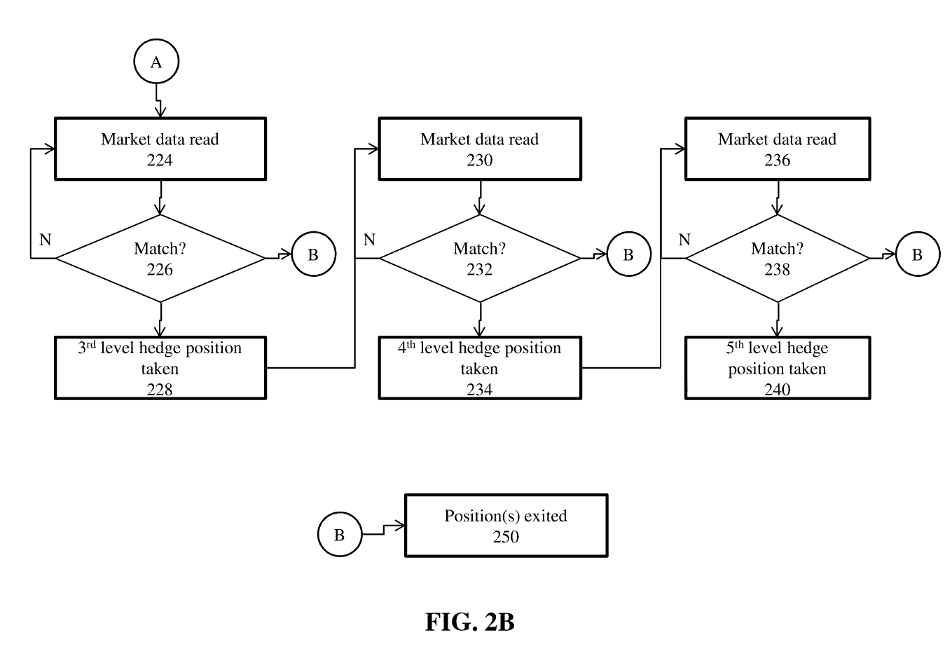

The following is a description of the process for defining an investment strategy definition and implementing the investment strategy in conjunction with the hedging actions of the present invention. FIG. 2 is a flow chart that shows the control flow of a process for providing management of hedging activities over a communications network, in accordance with one embodiment of the present invention.

In a first step 202, the user 130 utilizes his computer 132 to define his investment strategy definition 111. As described above, the investment strategy may comprise if-then statements, as well as other data. In step 204, the program logic 150 performs certain calculations based on the data entered by the user 130 in his investment strategy definition 111, wherein the calculations are later used to perform hedging actions. Examples of the calculations made by the program logic 150 in step 204 are described below.

The program logic 150 may calculate the number of transactions or operations (Ts) that will be executed over the amount of time defined by the user 130, as defined by the following equation:

Ts=(Ds×Op)

wherein Ds is the number of trading days over the amount of time defined by the user and Op is the average number of trading opportunities that arise each trading day for taking a market position.

The program logic 150 may also calculate the amount of money that may be traded per transaction (Pt) or operation over the amount of time defined by the user, as defined by the following equation:

Pt=Lc/Ts

wherein Lc represents the amount of money the user may comfortably lose, and Ts is the number of transactions or operations that will be executed over the amount of time defined by the user 130.

The program logic 150 may further calculate the amount of money that is predicted to be gained or lost based on the user's historical win/loss rate corresponding to his investment strategy definition 111, as defined by the following equations:

Predicted Gain=(% WinRate×Ts)×Pt Predicted Loss=(% LossRate×Ts)×Pt

wherein % WinRate and % LossRate represents the historical win rate and loss rate of the user's predefined investment strategy.

In one embodiment of the present invention, additionally in step 204, hedge definitions 113 and terminator actions 115 may be generated and stored in database 104 based on: a) the data that was collected from the user 130 in step 202 and/or b) the calculations defined for step 204. In another embodiment of the present invention, additionally in step 204, hedge definitions 113 and terminator actions 115 may be generated and stored in database 104 based on predefined data not related to the data entered by the user 130. In this embodiment, hedge definitions 113 and terminator actions 115 may be generated based on empirical data of the market 145.

In step 206, the program logic 150 continuously reads the market data received from market 145 and/or market data provider 150 and attempts to match the market data to the if-portions of the if-then statements of the investment strategy definition 111 of user 130. In step 208, the program logic 150 determines whether a match is made. If a match is made, the control flows to step 210. Otherwise, control flows back to step 206.

In step 210, a match was made between the market data and the if-portion(s) of at least one of the if-then statements of the investment strategy definition 111 of user 130, and therefore program logic 150 executes the then-portion of at the least one of the if-then statements of the investment strategy definition, thereby assuming an initial position in the market. A position is generally considered taking ownership of an “interest,” as defined above. For example, the then-statement may comprise a command to purchase a certain number of shares of a particular stock or a certain amount of a currency.

In step 212, the program logic 150 continuously reads the market data received from market 145 and/or market data provider 150 and attempts to: a) match the market data to the if-portions of the if-then statements of the first level of hedging action, as defined in definitions file 113, and b) match the market data to the if-portions of the if-then statements of the terminators actions, as defined in terminator file 115.

The if-portion of the first-level hedging action, i.e., the trigger point, may describe a target price or value of the interest of the initial position of step 210. This target price or value can be a predefined percent of the distance between the current price of the interest (of the initial position of step 210) and the maximum tolerated loss for that interest (as defined by user 130 in definition 111). In a first example, say the current price of the interest is $100 per share, the user owns one share, and the user 130 defined $50 as the maximum tolerated loss for that position. The trigger point may be 50% of the distance between the current price of the interest ($100 per share) and the maximum tolerated loss for that interest ($50 per share), which is $75 per share. Thus, when the interest reaches $75 per share, which equals 50% of the distance between the current price and the maximum tolerated loss, this triggers a corresponding first-level hedging action. The user 130 may predefine trigger points, the percentage of the distance between prices, maximum tolerated loss, etc. in the definition file 111 and hedge definitions file 113.

A hedge is an investment position intended to offset potential losses that may be incurred by a companion investment. Thus, a hedging action entails taking a hedge position that is typically opposite to the position being hedged. In the first example above, the first level hedging action would be, for example, to short sale an equal value of a stock considered to be a competitor of the stock of the initial position.

The trigger point can alternatively be a predefined percent of the distance between the current price of the interest (of the initial position of step 210) and the maximum tolerated gain for that interest (as defined by user 130 in definition 111). In a second example, say the current price of the interest is $100 per share, the user owns one share, and the user 130 defined $50 as the maximum tolerated gain for that position. The trigger point may be 50% of the distance between the current price of the interest ($100 per share) and the maximum tolerated gain for that interest ($150 per share), which is $125 per share. Thus, when the interest reaches $125 per share, which equals 50% of the distance between the current price and the maximum tolerated gain, this triggers a corresponding first-level hedging action, which may be different from the first-level hedging action taken if the interest gains in price, as described above (i.e., a long position is taken in an equal value of the stock). Alternatively, the first-level hedging action taken in this case may be the same as the first-level hedging action taken if the interest gains in price, as described above.

In step 214, the program logic 150 determines whether: a) a match is made between the market data (pertaining to the initial position) and the if-portions of the if-then statements of the first level of hedging action (defined in 113) or b) a match is made between the market data and the if-portions of the if-then statements of the terminator action (defined in 115). If a match is made to the first level of hedging action, the control flows to step 216. If a match is made to the terminator action, the control flows to step 250. Otherwise, control flows back to step 212.

In step 216, a match was made between the market data and the triggering event(s) of the first-level hedging action, and therefore program logic 150 executes the first-level hedging action, thereby assuming a first-level hedge position in the market, wherein the first-level hedge position is calculated to hedge the initial position of step 210. At least one of the calculations made in calculating the first-level hedging position is to calculate the amount or size of the first-level hedging position, which may be based at least on the size of (or monetary amount and/or number of shares of) the initial position of step 210. The amount or size of the first-level hedging position may further be based on any of the data entered by the user 130 in definition 111 and/or the data in hedge definition file 113.

In step 218, the program logic 150 continuously reads the market data received from market 145 and/or market data provider 150 and attempts to: a) match the market data to the scenario(s) that act as the triggering event(s) for a second level of hedging action, as defined in definitions file 113, and b) match the market data to the if-portions of the if-then statements of the terminators actions, as defined in terminator file 115.

In step 220, the program logic 150 determines whether: a) a match is made between the market data (pertaining to the first level hedge position) and the if-portions of the if-then statements of the second level of hedging action or b) a match is made between the market data to the if-portions of the if-then statements of the terminator action. If a match is made to the second level of hedging action, the control flows to step 222. If a match is made to the terminator action, the control flows to step 250. Otherwise, control flows back to step 218.

In step 222, a match was made between the market data and the triggering event(s) of the second-level hedging action, and therefore program logic 150 executes the second-level hedging action, thereby assuming a second-level hedge position in the market, wherein the second level hedging position hedges the first level hedging position taken in step 216. A second-level hedging action is similar to a first-level hedging action except that the second level hedge position seeks to hedge the first level hedge position. A second-level hedging action is further calculated similarly to a first-level hedging action (i.e., it is based on the character and specifics, such as the size and monetary amount of, the first-level hedging action).

In step 224, the program logic 150 continuously reads the market data received from market 145 and/or market data provider 150 and attempts to: a) match the market data to the scenario(s) that act as the triggering event(s) for a third level of hedging action, as defined in definitions file 113, and b) match the market data to the if-portions of the if-then statements of the terminators actions, as defined in terminator file 115.

In step 226, the program logic 150 determines whether a) a match is made between the market data (pertaining to the second level hedge position) and the if-portions of the if-then statements of the third level of hedging action or b) a match is made between the market data to the if-portions of the if-then statements of the terminator action. If a match is made to the third level of hedging action, the control flows to step 228. If a match is made to the terminator action, the control flows to step 250. Otherwise, control flows back to step 224.

In step 228, a match was made between the market data and the triggering event(s) of the third-level hedging action, and therefore program logic 150 executes the third-level hedging action, thereby assuming a third -level hedge position in the market, wherein the third level hedging position hedges the second level hedging position. A third-level hedging action is similar to a second-level hedging action except that the third level hedge position seeks to hedge the second level hedge position. A third-level hedging action is further calculated similarly to a second-level hedging action.

In step 230, the program logic 150 continuously reads the market data received from market 145 and/or market data provider 150 and attempts to: a) match the market data to the scenario(s) that act as the triggering event(s) for a fourth level of hedging action, as defined in definitions file 113, and b) match the market data to the if-portions of the if-then statements of the terminators actions, as defined in terminator file 115.

In step 232, the program logic 150 determines whether: a) a match is made between the market data (pertaining to the third level hedge position) and the if-portions of the if-then statements of the fourth level of hedging action or b) a match is made between the market data to the if-portions of the if-then statements of the terminator action. If a match is made to the fourth level of hedging action, the control flows to step 234. If a match is made to the terminator action, the control flows to step 250. Otherwise, control flows back to step 230.

In step 234, a match was made between the market data and the triggering event(s) of the fourth -level hedging action, and therefore program logic 150 executes the fourth-level hedging action, thereby assuming a fourth -level hedge position in the market, wherein the fourth level hedging position hedges the third level hedging position. A fourth-level hedging action is similar to a third-level hedging action except that the fourth level hedge position seeks to hedge the third level hedge position. A fourth-level hedging action is further calculated similarly to a third-level hedging action.

In step 236, the program logic 150 continuously reads the market data received from market 145 and/or market data provider 150 and attempts to: a) match the market data to the scenario(s) that act as the triggering event(s) for a fifth level of hedging action, as defined in definitions file 113, and b) match the market data to the if-portions of the if-then statements of the terminators actions, as defined in terminator file 115.

In step 238, the program logic 150 determines whether: a) a match is made between the market data (pertaining to the fourth level hedge position) and the if-portions of the if-then statements of the fifth level of hedging action or b) a match is made between the market data to the if-portions of the if-then statements of the terminator action. If a match is made to the fifth level of hedging action, the control flows to step 240. If a match is made to the terminator action, the control flows to step 250. Otherwise, control flows back to step 236.

In step 240, a match was made between the market data and the triggering event(s) of the fifth-level hedging action, and therefore program logic 150 executes the fifth-level hedging action, thereby assuming a fifth-level hedge position in the market, wherein the fifth level hedging position hedges the fourth level hedging position. A fifth-level hedging action is similar to a fourth-level hedging action except that the fifth level hedge position seeks to hedge the fourth level hedge position. A fifth-level hedging action is further calculated similarly to a fourth-level hedging action.

In step 250, a match was made between the market data and the triggering event(s) of the terminator action defined in file 115, and therefore program logic 150 executes the exit of the initial position in step 210 and any intervening hedge positions that may have been taken in steps 216, 222, 228, 234 and/or step 240. Exiting a position may comprise a transaction wherein ownership of an interest is sold or transacted in another step. The if-portion of the terminator action, i.e., the trigger point, may describe a target price or value of any of the interests of the initial position of step 210 and any intervening hedge positions that may have been taken in steps 216, 222, 228, 234 and/or step 240. The target price or value can be a predefined percent of the distance between the current price of the interest (of any or some of the positions defined above) and the maximum tolerated loss or gain for that interest (which may be defined by user 130 in definition 111).

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as floppy, ROM, flash memory, disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method on a computer for performing automated hedging activities, comprising:
receiving, from an investor, an investment strategy definition that defines at least one scenario associated with an initial position that must be executed, and wherein the investment strategy further defines a maximum intended gain value and a maximum intended loss value;
receiving market data;
searching the market data for the at least one scenario of the investment strategy definition;
matching market data with the at least one scenario of the investment strategy definition;
responsive to matching the market data, executing the initial position associated with the at least one scenario, wherein the initial position includes an interest having a first price;
receiving market data pertaining to the initial position;
searching the market data for at least one scenario associated with a first level hedge position that must be executed, wherein the at least one scenario comprises a first numerical value representing a value of the interest that corresponds to a predefined percentage of the maximum intended gain value and a second numerical value representing a value of the interest that corresponds to a predefined percentage of the maximum intended loss value;
matching market data with the at least one scenario of the first level hedge position; and
responsive to matching the market data with the at least one scenario of the first level hedge position, calculating the first level hedge position based on the initial position, and executing the first level hedge position that hedges the initial position.

2. The method of claim 1, further comprising:
receiving market data pertaining to the initial position and the first level hedge position;
searching the market data for at least one scenario associated with a terminator action, wherein the at least one scenario comprises a first numerical value representing a value of the aforementioned interests that corresponds to a predefined percentage of a maximum intended gain value and a second numerical value representing a value of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

3. The method of claim 2, further comprising:
receiving market data pertaining to the first level hedge position;
searching the market data for at least one scenario associated with a second level hedge position that must be executed, wherein the at least one scenario comprises a first numerical value representing a value of the interest of the first level hedge position that corresponds to a predefined percentage of a maximum intended gain value and a second numerical value representing a value of the interest of the first level hedge position that corresponds to a predefined percentage of a maximum intended loss value;
matching market data with the at least one scenario of the second level hedge position; and
responsive to matching the market data with the at least one scenario of the second level hedge position, calculating the second level hedge position based on the first level hedge position, and executing the second level hedge position that hedges the first level position.

4. The method of claim 3, further comprising:
receiving market data pertaining to the initial position, the first level hedge position and the second level hedge position;
searching the market data for at least one scenario associated with a terminator action, wherein the at least one scenario comprises a first numerical value representing a value of the aforementioned interests that corresponds to a predefined percentage of a maximum intended gain value and a second numerical value representing a value of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

5. The method of claim 4, further comprising:
receiving market data pertaining to the second level hedge position;
searching the market data for at least one scenario associated with a third level hedge position that must be executed, wherein the at least one scenario comprises a first numerical value representing a value of the interest of the second level hedge position that corresponds to a predefined percentage of a maximum intended gain value and a second numerical value representing a value of the interest of the second level hedge position that corresponds to a predefined percentage of a maximum intended loss value;
matching market data with the at least one scenario of the third level hedge position; and
responsive to matching the market data with the at least one scenario of the third level hedge position, calculating the third level hedge position based on the second level hedge position, and executing the third level hedge position that hedges the second level position.

6. The method of claim 5, further comprising:
receiving market data pertaining to the initial position, the first level hedge position, the second level hedge position and the third level hedge position;
searching the market data for at least one scenario associated with a terminator action, wherein the at least one scenario comprises a first numerical value representing a value of the aforementioned interests that corresponds to a predefined percentage of a maximum intended gain value and a second numerical value representing a value of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

7. The method of claim 6, further comprising:
receiving market data pertaining to the third level hedge position;
searching the market data for at least one scenario associated with a fourth level hedge position that must be executed, wherein the at least one scenario comprises a first numerical value representing a value of the interest of the third level hedge position that corresponds to a predefined percentage of a maximum intended gain value and a second numerical value representing a value of the interest of the third level hedge position that corresponds to a predefined percentage of a maximum intended loss value;
matching market data with the at least one scenario of the fourth level hedge position; and
responsive to matching the market data with the at least one scenario of the fourth level hedge position, calculating the fourth level hedge position based on the third level hedge position, and executing the fourth level hedge position that hedges the third level position.

8. The method of claim 7, further comprising:
receiving market data pertaining to the initial position, the first level hedge position, the second level hedge position, the third level hedge position and the fourth level hedge position;
searching the market data for at least one scenario associated with a terminator action, wherein the at least one scenario comprises a first numerical value representing a value of the aforementioned interests that corresponds to a predefined percentage of a maximum intended gain value and a second numerical value representing a value of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

9. The method of claim 8, further comprising:
receiving market data pertaining to the fourth level hedge position;
searching the market data for at least one scenario associated with a fifth level hedge position that must be executed, wherein the at least one scenario comprises a first numerical value representing a value of the interest of the fourth level hedge position that corresponds to a predefined percentage of a maximum intended gain value and a second numerical value representing a value of the interest of the fourth level hedge position that corresponds to a predefined percentage of a maximum intended loss value;
matching market data with the at least one scenario of the fifth level hedge position; and
responsive to matching the market data with the at least one scenario of the fifth level hedge position, calculating the fifth level hedge position based on the fourth level hedge position, and executing the fifth level hedge position that hedges the fourth level position.

10. The method of claim 9, further comprising:
receiving market data pertaining to the initial position, the first level hedge position, the second level hedge position, the third level hedge position, the fourth level hedge position and the fifth level hedge position;
searching the market data for at least one scenario associated with a terminator action, wherein the at least one scenario comprises a first numerical value representing a value of the aforementioned interests that corresponds to a predefined percentage of a maximum intended gain value and a second numerical value representing a value of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

11. A method on a computer for performing automated hedging activities, comprising:
receiving, from an investor, an investment strategy definition that defines a price of an interest for an initial position that must be executed, and wherein the investment strategy further defines a maximum intended gain value and a maximum intended loss value;
receiving market data;
searching the market data for the price of the interest of the investment strategy definition;
matching market data with the price of the interest of the investment strategy definition;
responsive to matching the market data, executing the initial position associated with the price of the interest, wherein the initial position comprises the interest having a first price;
receiving market data pertaining to the initial position;
searching the market data for at least one scenario associated with a first level hedge position that must be executed, wherein the at least one scenario comprises a price of the interest that corresponds to a predefined percentage of the maximum intended gain value and a price of the interest that corresponds to a predefined percentage of the maximum intended loss value;
matching market data with the at least one scenario of the first level hedge position; and
responsive to matching the market data with the at least one scenario of the first level hedge position, calculating the first level hedge position based on the initial position, and executing the first level hedge position that hedges the initial position.

12. The method of claim 11, further comprising:
receiving market data pertaining to the initial position and the first level hedge position;
searching the market data for at least one scenario associated with a terminator action, wherein the at least one scenario comprises a price of the aforementioned interests that corresponds to a predefined percentage of a maximum intended gain value and a price of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.

13. A method on a computer for performing automated hedging activities, comprising:
receiving, from an investor, an investment strategy definition that defines a price of an interest for an initial position that must be executed, and wherein the investment strategy further defines a maximum intended gain value and a maximum intended loss value;
receiving market data;
searching the market data for the price of the interest of the investment strategy definition;
matching market data with the price of the interest of the investment strategy definition;
responsive to matching the market data, executing the initial position associated with the price of the interest, wherein the initial position comprises the interest having a first price;
receiving market data pertaining to the initial position;
searching the market data for at least one scenario associated with a first level hedge position that must be executed, wherein the at least one scenario comprises a price of the interest that corresponds to a predefined percentage of the maximum intended gain value and a price of the interest that corresponds to a predefined percentage of the maximum intended loss value;
matching market data with the at least one scenario of the first level hedge position; and
responsive to matching the market data with the at least one scenario of the first level hedge position, calculating the first level hedge position based on a number of shares and average share price of the initial position, and executing the first level hedge position that hedges the initial position.

14. The method of claim 13, further comprising:
receiving market data pertaining to the initial position and the first level hedge position;
searching the market data for at least one scenario associated with a terminator action, wherein the at least one scenario comprises a price of the aforementioned interests that corresponds to a predefined percentage of a maximum intended gain value and a price of the aforementioned interests that corresponds to a predefined percentage of a maximum intended loss value;
matching market data with the at least one scenario of the terminator action;
responsive to matching the market data with the at least one scenario of the terminator action, executing the terminator action, thereby exiting from the aforementioned positions.
